(19) United States
(12) Patent Application Publication
(10) Pub. No.: US 2025/0109955 A1
(43) Pub. Date: Apr. 3, 2025

(54) ELECTRONIC CONTROL DEVICE AND VEHICLE CONTROL METHOD

(71) Applicant: Hitachi Astemo, Ltd., Hitachinaka-shi, Ibaraki (JP)

(72) Inventors: Hirofumi IKOMA, Ibaraki (JP); Keiichiro NAGATSUKA, Ibaraki (JP)

(73) Assignee: Hitachi Astemo, Ltd., Hitachinaka-shi, Ibaraki (JP)

(21) Appl. No.: 18/832,064

(22) PCT Filed: Jul. 19, 2022
(86) PCT No.: PCT/JP2022/028121

§ 371 Date: Jul. 22, 2024

(30) Foreign Application Priority Data
Feb. 7, 2022 (JP) 2022-016886

(51) Int. Cl. G01C 21/34; G05B 13/02

(52) U.S. Cl. CPC G01C 21/3484; G01C 21/3492; G05B 13/028

(57) ABSTRACT

An electronic control device including a travel experience determination unit that determines travel experience at a travel position of an own vehicle; a collective knowledge storage unit that stores collective knowledge information generated from data related to operations of a plurality of vehicles; an empirical knowledge storage unit that stores empirical knowledge information generated from data related to operation of the own vehicle; a combination ratio determination unit that determines a combination ratio pattern of the collective knowledge information and the empirical knowledge information; and a data generation unit that generates control data for the own vehicle by combining the collective knowledge information and the empirical knowledge information based on the travel experience and the combination ratio pattern.

### INCORPORATION BY REFERENCE

This application claims priority to Japanese Patent Application No. 2022-16886 filed on Feb. 7, 2022 (2022), the contents of which are incorporated herein by reference.

### TECHNICAL FIELD

The present invention relates to an electronic control device, and more particularly to a vehicle control method effective for driving assistance such as erroneous operation determination.

### BACKGROUND ART

Determination data such as a threshold value is set as a trigger for function implementation in the erroneous operation suppressing function such as erroneous depression preventing function and lane deviation preventing function. As one of determination data setting methods, there is a method of using collective knowledge. This method determines determination data from a set of operations of a plurality of vehicles. In a case where the operation of the own vehicle traveling through the relevant place is greatly different from the operation of the other vehicle, determination is made as an erroneous operation, and the erroneous operation suppressing function is activated.

As background art of the present technical field, there are the following patent literature. PTL 1 (JP 2005-99930 A) discloses a vehicle travel control system that performs automatic steering control of a vehicle based on travel information of the vehicle, the vehicle travel control system including: an information center; and an in-vehicle device mounted on the vehicle and capable of communicating with the information center, where the information center includes: a center-side reception means configured to receive the travel information from a plurality of vehicles, a center-side recommended travel information generation means configured to generate center-side recommended travel information based on the plurality of travel information received by the center-side reception means, and a center-side transmission means configured to transmit the center-side recommended travel information generated by the center-side recommended travel information generation means; and the in-vehicle device includes an in-vehicle device side reception means configured to receive the center-side recommended travel information transmitted by the center-side transmission means, and a control means configured to control steering of the own vehicle based on the center-side recommended travel information received by the in-vehicle device side reception means.

Furthermore, paragraph 0063 to 0064 of PTL 1 describes “Specifically, statistical processing is performed by merging the center-side recommended travel line information and the information on the travel line stored in the own vehicle. That is, the in-vehicle device side recommended travel line is not generated based only on the travel information recorded by the in-vehicle device, but is generated from the travel information recorded by the in-vehicle device and the center-side recommended travel line information. Specifically describing, the statistical processing calculation unit combines the travel line (for one travel) of the own vehicle and the center-side recommended travel line at a ratio of 1:5 to generate the in-vehicle device side recommended travel line information. That is, the center-side recommended travel line has a weight for five traveling of the travel line (one travel) of the own vehicle.”

### SUMMARY OF INVENTION

### Technical Problem

As described above, in the vehicle travel control system described in PTL 1, the information center receives travel information from a plurality of vehicles and generates center-side recommended travel information based on the received travel information, and on the other hand, the information center generates in-vehicle device side recommended travel information based on the information in which the own vehicle has traveled in the past, and merges the generated recommended travel information with the center-side recommended travel information by statistical processing to set determination data that can reflect user's preference at a place where the own vehicle has traveled a lot.

However, since the center-side recommended information and the in-vehicle device side recommended information are combined and merged at a unique ratio, there is a limit to reflecting user's preference. In addition, since the preference of the user is reflected, the determination data may be set in a direction in which the activation timing of the erroneous operation suppressing function is delayed.

### Solution to Problem

A representative example of the invention disclosed in the present application is as follows. That is, an electronic control device includes a travel experience determination unit that determines travel experience at a travel position of an own vehicle; a collective knowledge storage unit that stores collective knowledge information generated from data related to operations of a plurality of vehicles; an empirical knowledge storage unit that stores empirical knowledge information generated from data related to operation of the own vehicle; a combination ratio determination unit that determines a combination ratio pattern of the collective knowledge information and the empirical knowledge information; and a data generation unit that generates control data for the own vehicle by combining the collective knowledge information and the empirical knowledge information based on the travel experience and the combination ratio pattern.

### Advantageous Effects of Invention

According to one aspect of the present invention, it is possible to combine the collective knowledge information and the empirical knowledge information according to the travel environment and the travel experience to achieve both safety and convenience. Problems, configurations, and effects other than those described above will be clarified by the following description of examples.

### BRIEF DESCRIPTION OF DRAWINGS

FIG. 1 is a diagram illustrating an example of an overall configuration of a driving assistance device and a control center according to an example of the present invention.

FIG. 2 is a diagram illustrating a modified example of the overall configuration of the driving assistance device and the control center according to the example of the present invention.

FIG. 3 is a diagram illustrating a modified example of the overall configuration of the driving assistance device and the control center according to the example of the present invention.

FIG. 4 is a diagram illustrating a configuration of a determination data generation unit.

FIG. 5 is a diagram illustrating a travel situation in a parking lot which is a representative environment in which the present example is effective.

FIG. 6 is a diagram illustrating a grid in a parking lot which is a representative environment in which the present example is effective.

FIG. 7 is a diagram illustrating a simple configuration example of a combination ratio between collective knowledge information and empirical knowledge information.

FIG. 8 is a diagram illustrating a general configuration example of a combination ratio between collective knowledge information and empirical knowledge information.

FIG. 9 is a diagram illustrating an example in which empirical knowledge information of a combination ratio between collective knowledge information and empirical knowledge information is emphasized.

FIG. 10 is a diagram illustrating an example in which collective knowledge information of a combination ratio between collective knowledge information and empirical knowledge information is emphasized.

### DESCRIPTION OF EMBODIMENTS

Hereinafter, an example of a driving assistance device will be described as an example of an electronic control device of the present invention with reference to the drawings.

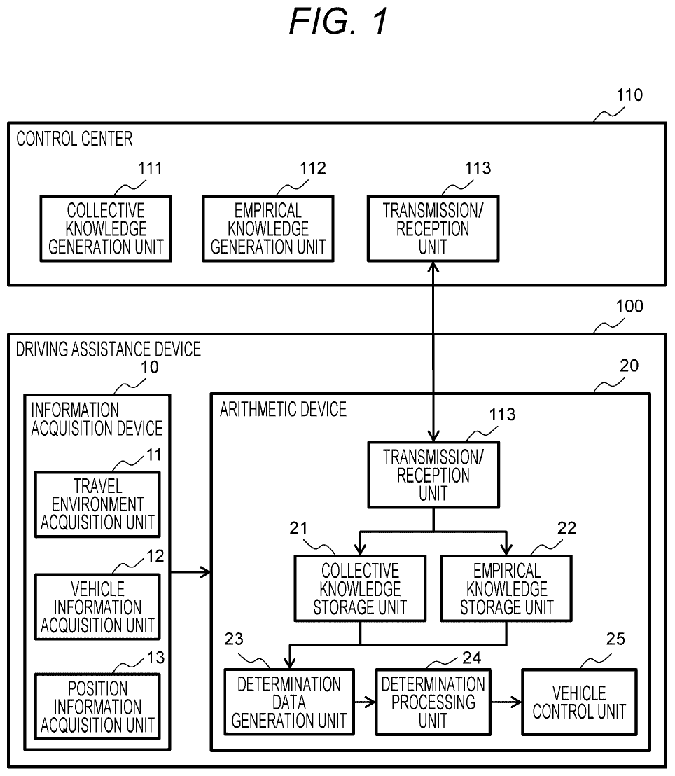

FIGS. 1 to 3 are diagrams illustrating an example of an overall configuration of a driving assistance device 100 and a control center 110 according to an example of the present invention.

A driving assistance device 100 illustrated in FIG. 1 is a device that generates control data necessary when an own vehicle 1 performs an erroneous operation suppressing function and determines an erroneous operation, and includes an information acquisition device 10 and an arithmetic device 20. The control data is, for example, determination data that is a threshold value for determining an erroneous operation in the erroneous operation suppressing function and activating the function, or a control target value in an automatic driving function. The arithmetic device 20 includes a microcomputer, a storage device, and a communication interface. The microcomputer is a processor (e.g., a CPU) that executes a program stored in the storage device. The microcomputer executes a predetermined program to operate as a functional unit that provides various functions. The storage device includes a nonvolatile storage area and a volatile storage area. The nonvolatile storage area includes a program area for storing a program executed by the microcomputer and a data area for temporarily storing data used when the microcomputer executes the program. The volatile storage area stores data used when the microcomputer executes the program. The communication interface is connected to another electronic control device through a network such as CAN or Ethernet.

The control center 110 is a device that generates collective knowledge and empirical knowledge necessary for the driving assistance device 100 to generate control data, and includes a collective knowledge generation unit 111, an empirical knowledge generation unit 112, and a transmission/reception unit 113. Note that the collective knowledge generation unit 111 and the empirical knowledge generation unit 112 execute processes in the control center 110 since the processing load in the generation process increases, but the processes may be executed by the arithmetic device 20 of the driving assistance device 100. In the configuration example illustrated in FIG. 1, since the control center 110 generates the collective knowledge information and the empirical knowledge information and transmits the generated collective knowledge information and the empirical knowledge information to the driving assistance device 100 via the transmission/reception unit 113, the vehicle can be accurately controlled using the latest collective knowledge information of the control center. In addition, even in a case where the processing capacity of the arithmetic device 20 is insufficient, the vehicle can be accurately controlled by compounding the collective knowledge information and the empirical knowledge information.

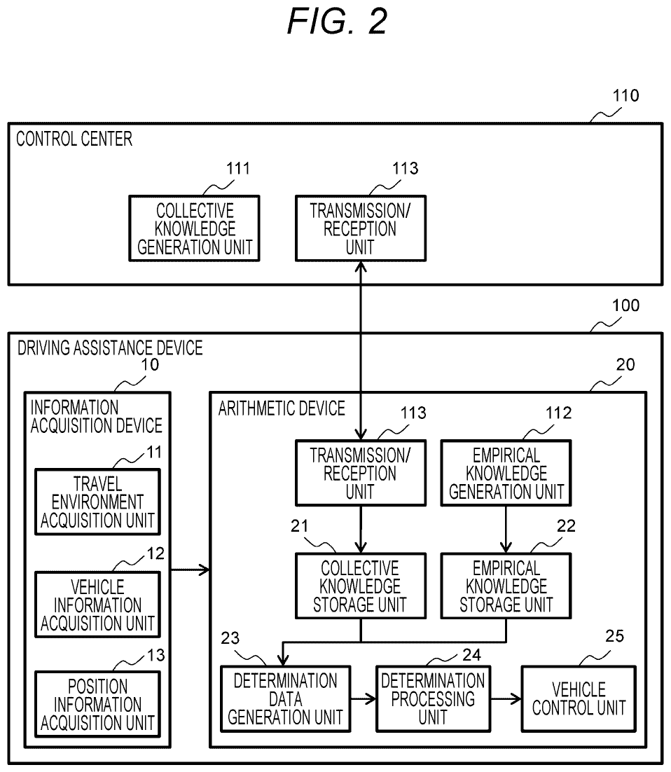

FIG. 2 is a diagram illustrating a modified example of the overall configuration of the driving assistance device 100 and the control center 110 according to the example of the present invention. In the modified example illustrated in FIG. 2, the empirical knowledge generation unit 112 is provided not in the control center 110 but in the driving assistance device 100, that is, the arithmetic device 20. In this manner, the control center 110 generates the collective knowledge information, and transmits the generated collective knowledge information to the driving assistance device 100 via the transmission/reception unit 113, and the driving assistance device 100 generates the empirical knowledge information, so that the vehicle can be accurately controlled using the latest collective knowledge information generated by the control center 110. In addition, the communication amount for acquiring the empirical knowledge from the control center 110 can be reduced by generating the empirical knowledge on the vehicle side.

FIG. 3 is a diagram illustrating a modified example of the overall configuration of the driving assistance device 100 and the control center 110 according to the example of the present invention. In the modified example illustrated in FIG. 3, a collective knowledge storage unit 21 stores the collective knowledge information generated in advance at the time of factory shipment, and the collective knowledge information is updated at the time of periodic inspection and repair of the vehicle. The collective knowledge information and the empirical knowledge information can be compounded without providing the control center 110 that distributes the collective knowledge information by storing the empirical knowledge in advance on the vehicle side.

Next, an example for a case where the collective knowledge generation unit 111 and the empirical knowledge generation unit 112 generate determination data which is a threshold value for activating the erroneous operation suppressing function as control data with reference to FIG. 1 calculated by the control center 110 will be described.

### (Information Acquisition Device 10)

The information acquisition device 10 is a device that acquires a travel environment around the own vehicle 1, vehicle information of the own vehicle 1, and position information of the own vehicle 1, and includes a travel environment acquisition unit 11, a vehicle information acquisition unit 12, and a position information acquisition unit 13.

The travel environment acquisition unit 11 extracts a degree of congestion of the traveling vehicle existing around the own vehicle 1, and travel environment information of a road surface condition (paved road, dirt, wet road surface, dry road surface, etc.) and weather (clear, rainy, snowy, foggy, etc.) of the road on which the own vehicle 1 travels based on an observation result of the outside world by a radar sensor using a millimeter wave, a laser, or the like or an external sensor such as a camera using an imaging element mounted on the own vehicle 1, and outputs the extracted information to the arithmetic device 20. In addition, the travel environment acquisition unit 11 may acquire travel environment information such as a degree of congestion, a road surface condition, and weather of a road on which the own vehicle 1 travels using a car navigation system or the like.

The vehicle information acquisition unit 12 acquires vehicle information regarding the operation of the vehicle such as the traveling speed and the steering wheel angle of the own vehicle 1 based on the output of a vehicle sensor such as a speed sensor and a steering angle sensor mounted on the own vehicle 1, and outputs the vehicle information to the arithmetic device 20. In addition, since required vehicle information varies depending on which erroneous operation is to be suppressed, the vehicle information acquisition unit 12 may appropriately acquire a required type of vehicle information depending on the erroneous operation suppressing function.

The position information acquisition unit 13 acquires the current position of the own vehicle 1 based on information of a global positioning system (GPS), a global navigation satellite system (GNSS), a gyro sensor or the like, and outputs the current position to the arithmetic device 20.

### (Arithmetic Device 20)

The arithmetic device 20 is a device that generates determination data based on the travel environment, the vehicle information, and the position information acquired from the information acquisition device 10 and determines an erroneous operation, and includes a transmission/reception unit 113, a collective knowledge storage unit 21, an empirical knowledge storage unit 22, a determination data generation unit 23, a determination processing unit 24, and a vehicle control unit 25. Note that the arithmetic device 20 is specifically a microcomputer mounted on a CPU or an electronic control unit (ECU) including a memory (ROM, RAM), and is a device that realizes each function such as the determination data generation unit 23 by the CPU executing various processing programs stored in the memory.

The collective knowledge storage unit 21 stores collective knowledge information generated from data regarding operations of a plurality of vehicles including other vehicles generated by the collective knowledge generation unit 111. The collective knowledge information is, for example, a determination threshold value of an erroneous operation suppressing function generated from data obtained by collecting operations of a plurality of vehicles. The empirical knowledge storage unit 22 stores empirical knowledge information generated from data regarding the operation of the own vehicle generated by the empirical knowledge generation unit 112. The empirical knowledge information is, for example, a determination threshold value of the erroneous operation suppressing function generated from data obtained by collecting the operation of the own vehicle. The determination data generation unit 23 combines the collective knowledge information and the empirical knowledge information at a predetermined combination ratio to generate determination data that is data for control at the own vehicle position. The determination processing unit 24 determines an erroneous operation occurring in the own vehicle 1 based on the determination data and the vehicle information of the own vehicle 1.

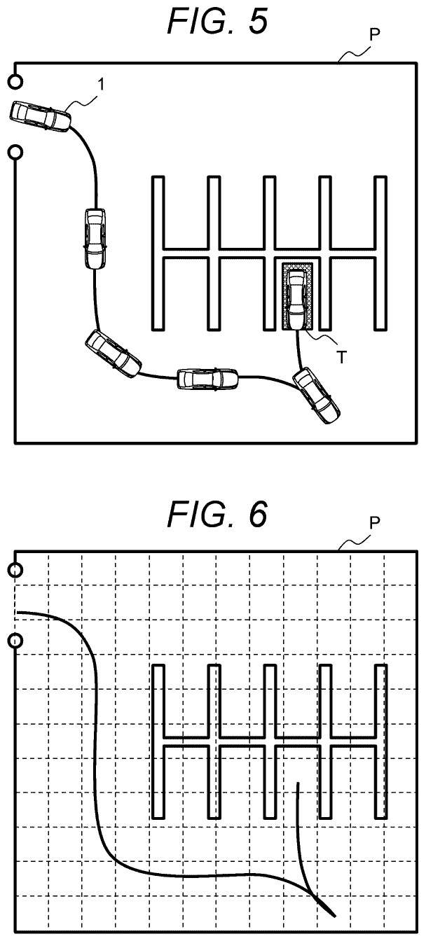

FIG. 5 is a diagram illustrating a representative environment in which the present example is effective. As illustrated in FIG. 5, when the own vehicle 1 mistakenly depresses the brake pedal and the accelerator pedal at the time of parking in the parking space T in the parking lot P, the erroneous depression preventing function is activated, but when the erroneous depression preventing function is activated even if the erroneous depression is not performed, the convenience is deteriorated. Thus, it is necessary to appropriately set determination data for activating the erroneous depression preventing function.

In a conventional vehicle travel control system, in order to appropriately set the determination data, an information center receives travel a information from plurality of vehicles, a center side generates recommended travel information based on the received travel information, and distributes the generated recommended travel information to the vehicles. In the example of the present invention, on the vehicle side, recommended travel information is generated based on information on past travel of the own vehicle, and statistical processing is performed by merging with the recommended travel information distributed from the center side, thereby generating determination data that can reflect user's preference at a place where the own vehicle frequently passes. However, when the recommended travel information generated on the center side and the recommended travel information generated on the vehicle side are merged at a unique ratio, the user's preference can be reflected to some extent, but there is an upper limit to reflecting the user's preference, and there is a problem that determination data is set such that the activation timing of the erroneous operation suppressing function is delayed because the user's preference is reflected.

Therefore, the driving assistance device 100 and the control center 110 of the present example extract the collective knowledge information from the collective knowledge storage unit 21 based on the own vehicle position information acquired by the position information acquisition unit 13, and extract the empirical knowledge information from the empirical knowledge storage unit 22. Then, the determination data generation unit 23 determines a combination ratio of the collective knowledge information and the empirical knowledge information based on the travel environment around the own vehicle 1 and the travel experience at the place acquired by the travel environment acquisition unit 11, and generates the determination data. Therefore, depending on the travel environment around the own vehicle 1 and the travel experience, it is possible to emphasize the collective knowledge information in order to enhance the safety and to emphasize the empirical knowledge information in order to enhance the convenience. As a result, unlike the conventional system described above, the determination data can be appropriately set according to the situation. Details of each unit of the driving assistance device 100 and the control center 110 outlined above will be described below.

### (Description on Method for Generating Collective Knowledge Information and Empirical Knowledge Information)

### <Collective Knowledge Generation Unit 111>

The collective knowledge generation unit 111 generates collective knowledge information by performing statistical processing such as averaging and dispersion based on data obtained by collecting operations of a plurality of vehicles including other vehicles. The collective knowledge information is determination data generated based on operations of a plurality of vehicles including other vehicles and used to activate an erroneous operation suppressing function. The determination data is stored in, for example, a table format as information associated with the position information. Specifically, in a case where an erroneous operation suppressing function for preventing an erroneous depression in the parking lot P illustrated in FIG. 5 is assumed, determination data for the erroneous operation suppressing function to be activated is a vehicle speed, a vehicle acceleration, and the like, and information on vehicle speeds, vehicle accelerations, and traveling positions of a plurality of vehicles are collected, and determination data is generated by statistical processing such as an average value and a variance value based on the collected data. The determination data may be an average value, or may be an average value and a standard deviation in consideration of a variance value. In the determination data generated in this manner, when the own vehicle 1 exceeds a threshold value determined by an average value or an average value and a standard deviation of a vehicle speed or a vehicle acceleration of another vehicle at the place, determination is made that the operation is an erroneous operation. The determination data is stored as, for example, information in a table format, but as illustrated in FIG. 6, the inside of the parking lot P may be divided into a grid shape, and determination data based on the vehicle operation in each cell associated with the coordinate position may be stored.

### <Empirical Knowledge Generation Unit 112>

The empirical knowledge generation unit 112 generates the empirical knowledge information by statistical processing such as averaging and dispersion based on the data obtained by collecting the operation of the own vehicle 1. The empirical knowledge information is determination data generated based on the operation of the own vehicle 1 and used to activate the erroneous operation suppressing function. The determination data is stored in, for example, a table format as information associated with the position information. In addition, the determination data may be stored as information associated with the observation result of the outside world by the external sensor. Specifically, similarly to the collective knowledge generation unit 111 described above, in a case where it is assumed that the erroneous operation suppressing function that prevents an erroneous depression in the parking lot P illustrated in FIG. 5 is performed, the determination data for the erroneous operation suppressing function to be activated is the vehicle speed, the vehicle acceleration, and the like, the vehicle speed and the vehicle acceleration, and the traveled position information of the own vehicle 1 are collected, and the determination data is generated by statistical processing such as the average value and the variance value based on the collected data. The determination data may be an average value, or may be an average value and a standard deviation in consideration of a variance value. In the determination data generated in this manner, when the own vehicle 1 exceeds a threshold value determined by an average value or an average value and a standard deviation of past own vehicle speeds and own vehicle accelerations at the relevant place, determination is made that the operation is an erroneous operation. The determination data is stored as, for example, information in a table format, but as illustrated in FIG. 6, the inside of the parking lot P may be divided into a grid shape, and determination data based on the vehicle operation in each cell associated with the coordinate position may be stored.

### (Description on Method of Compounding Collective Knowledge Information and Empirical Knowledge Information)

### <Determination Data Generation Unit 23>

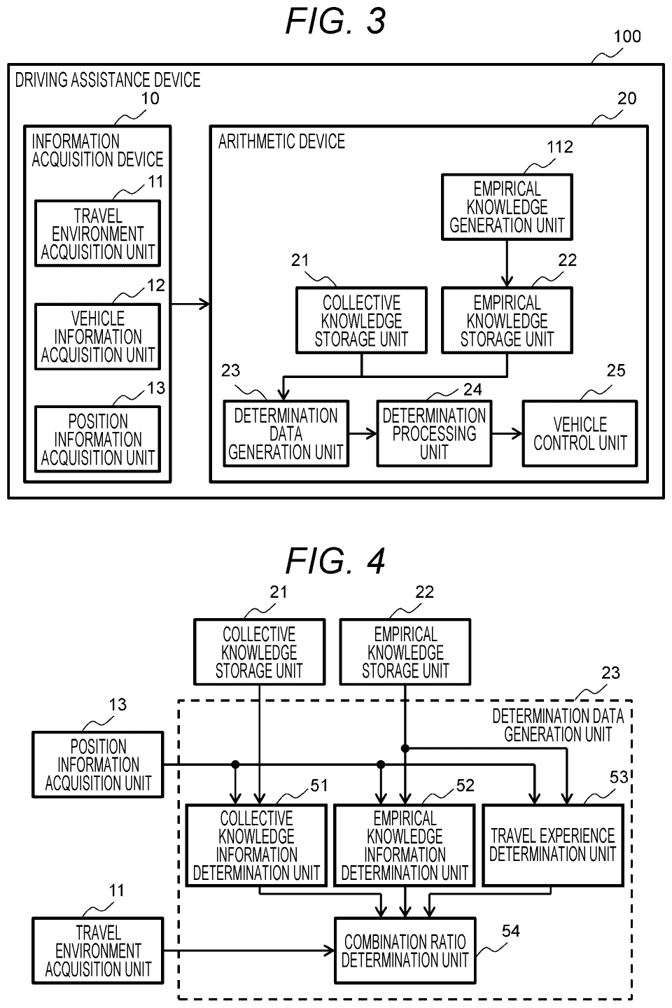

FIG. 4 is a diagram illustrating a configuration of the determination data generation unit 23. Based on the travel environment obtained by the travel environment acquisition unit 11, the position information obtained by the position information acquisition unit 13, the collective knowledge information stored in the collective knowledge storage unit 21, and the empirical knowledge information stored in the empirical knowledge storage unit 22, the determination data generation unit 23 generates determination data by compounding the collective knowledge information and the empirical knowledge information. The determination data generation unit 23 includes a collective knowledge information determination unit 51, an empirical knowledge information determination unit 52, a travel experience determination unit 53, and a combination ratio determination unit 54.

### <Collective Knowledge Information Determination Unit 51>

Based on the own vehicle position information acquired by the position information acquisition unit 13, the collective knowledge 51 information determination unit 5 determines the collective knowledge information from the collective knowledge information table stored in the collective knowledge storage unit 21.

### <Empirical Knowledge Information Determination Unit 52>

Based on the own vehicle position information acquired by the position information acquisition unit 13, the empirical knowledge information determination unit 52 determines the empirical knowledge information from the empirical knowledge information table stored in the empirical knowledge storage unit 22.

### <Travel Experience Determination Unit 53>

Based on the own vehicle position information acquired by the position information acquisition unit 13, the travel experience determination unit 53 determines, from the empirical knowledge information table stored in the empirical knowledge storage unit 22, the empirical knowledge of traveling the own vehicle position in the past. For example, there is a method of acquiring the past number of times of traveling the own vehicle position with the number of times of traveling as travel experience knowledge. In addition, the travel experience determination unit 53 may determine the empirical knowledge obtained by traveling in the past at the position corresponding to the observation result of the outside world from the empirical knowledge information table stored in the empirical knowledge storage unit 22 based on the observation result of the outside world by the external sensor.

### <Combination Ratio Determination Unit 54>

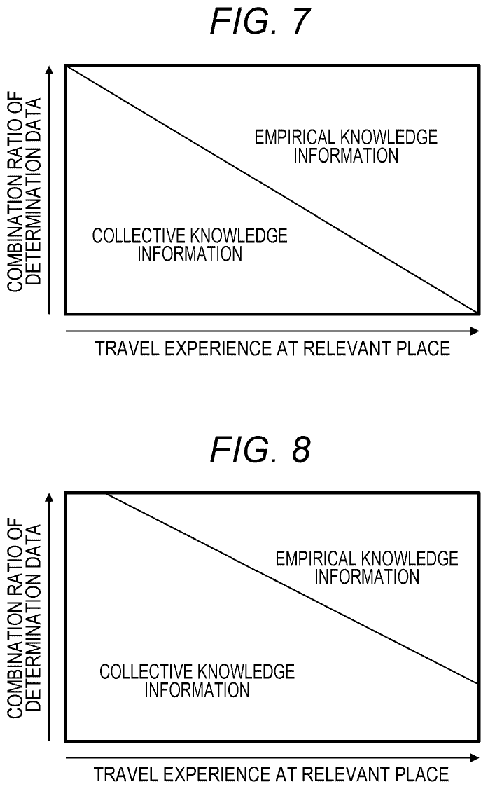

The combination ratio determination unit 54 determines a combination ratio pattern of the collective knowledge information and the empirical knowledge information based on the travel environment acquired by the travel environment acquisition unit 11 and the travel experience acquired by the travel experience determination unit 53. For example, the determination value is determined by a sum obtained by weighting each of the determination threshold value of the erroneous operation suppressing function generated from the collective knowledge information and the determination threshold value of the erroneous operation suppressing function generated from the empirical knowledge information with a ratio of a combination ratio. The combination ratio between the collective knowledge information and the empirical knowledge information can be determined by various methods as illustrated in FIGS. 7 to 10. In the combination ratio illustrated in FIGS. 7 to 10, the horizontal axis represents the travel experience, and the vertical axis represents the combination ratio of the determination data. The combination ratios illustrated in FIGS. 7 to 10 may be held in a table format or may be given by a function representing the illustrated combination ratio curve. When the combination ratio is given by a function, the distribution ratio does not change step by step, and continuity can be provided. In addition, the resolution of the distribution ratio can be improved.

The determination data is determined such that when the combination ratio of the determination data illustrated in FIG. 7 has the simplest configuration and the travel experience is zero, the collective knowledge information is 100%, the compounding of the empirical knowledge information is increased linearly with the increase in the travel experience, and when the travel experience reaches a predetermined value, the empirical knowledge information becomes 100%. The combination ratio illustrated in FIG. 7 increases the combination ratio of the collective knowledge information even if the travel experience is small. When the combination ratio is determined by this method, it is possible to generate determination data focusing on empirical knowledge information on a road that the driver is accustomed to, reduce the opportunity for the driver to feel uncomfortable, and improve convenience.

Although the combination ratio of the determination data illustrated in FIG. 8 linearly increases the compounding of the empirical knowledge information with the increase in the travel experience, the determination data is generated only with the collective knowledge information without using the empirical knowledge information until a predetermined number of travel experiences (e.g., the vehicle travels 10 times.) occur. Since the empirical knowledge is not sufficient and there is a possibility of an abnormal value if the number of times of traveling is small, it is possible to generate the determination data in which the empirical knowledge is compounded after the driver is accustomed to a certain degree, and it is possible to reduce the opportunity for the driver to feel uncomfortable and improve convenience while eliminating the abnormal value of the empirical knowledge with a small number of times of traveling.

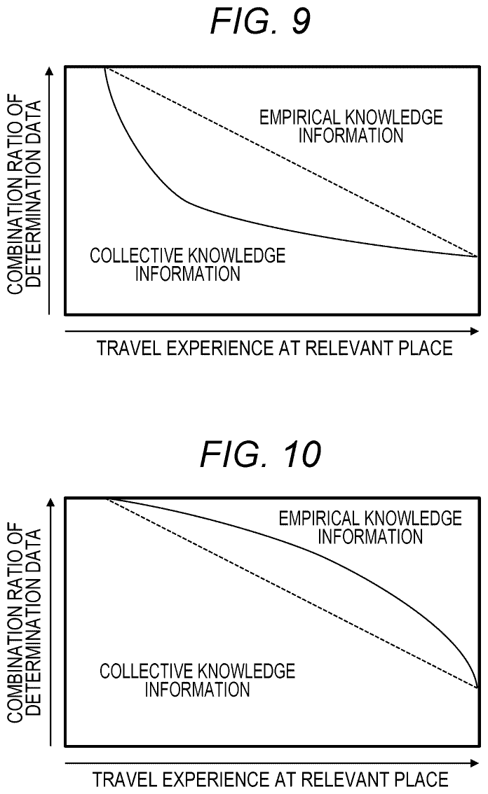

For the combination ratio of the determination data illustrated in FIG. 9, similarly to the combination ratio of the determination data illustrated in FIG. 8, until a predetermined number of travel experiences (e.g., the vehicle travels 10 times) occur, the determination data is generated only with the collective knowledge information without using the empirical knowledge information. In the combination ratio of the determination data illustrated in FIG. 9, the compounding of the empirical knowledge information is increased as the travel experience increases, but the combination ratio of the empirical knowledge information is increased as compared with a case where the combination ratio is linearly determined as illustrated in FIG. 8. When the combination ratio is determined by this method, it is possible to generate determination data based on the driver's preferred action, and the convenience can be improved.

For the combination ratio of the determination data illustrated in FIG. 10, similarly to the combination ratio of the determination data illustrated in FIG. 8, until a predetermined number of travel experiences (e.g., the vehicle travels 10 times) occur, the determination data is generated only with the collective knowledge information without using the empirical knowledge information. In the combination ratio of the determination data illustrated in FIG. 10, the compounding of the empirical knowledge information is increased as the travel experience increases, but the combination ratio of the empirical knowledge information is reduced as compared with a case where the combination ratio is linearly determined as illustrated in FIG. 8. When the combination ratio is determined by this method, determination data based on the operation of another vehicle can be generated, the possibility of contact with another vehicle can be reduced, and safety can be secured. Therefore, traffic congestion can be alleviated, and traffic trouble with other vehicles can be prevented.

As described above, the determination data can be generated with emphasis on either the collective knowledge information or the empirical knowledge information by using the combination ratio of various determination data. By selectively using these combination ratio patterns according to the travel environment, driving assistance suitable for the travel environment can be performed, and convenience and safety can be appropriately secured. For example, in a case where the road is empty, using the combination ratio that changes linearly illustrated in FIG. 8 in the normal state, the determination data based on the driver's preferred action can be generated, and convenience can be improved by using the combination ratio illustrated in FIG. 9. On the other hand, in a case where the road is congested, the determination data based on the operation of another vehicle can be generated, and safety can be secured by using the combination ratio illustrated in FIG. 10. For the travel environment, the combination ratio pattern may be selectively used in consideration of road surface conditions, weather, and the like in addition to the degree of congestion of the road.

### <Determination Processing Unit 24>

The determination processing unit 24 compares the vehicle information of the own vehicle 1 acquired by the vehicle information acquisition unit 12 with the determination data acquired by the determination data generation unit 23, and determines an erroneous operation. For example, when the determination data indicates 20 km/h while the vehicle is traveling in the parking lot P illustrated in FIG. 4, it is determined as an erroneous operation when the traveling speed becomes 20 km/h or more due to erroneous depression of the accelerator pedal and the brake pedal. The determination processing unit 24 outputs the determination result to vehicle control unit 25.

### <Vehicle Control Unit 25>

The vehicle control unit 25 suppresses an erroneous operation based on the determination result of the erroneous operation by the determination processing unit 24. For example, in an erroneous operation suppressing function for preventing an erroneous depression, control is performed to decelerate the vehicle and control is performed to suppress acceleration.

### Modified Example

In the first example described above, the erroneous depression preventing function in the parking lot P illustrated in FIG. 5 has been described as a representative scene in which the present invention is effective, but the present invention can generate determination data of other various erroneous operation suppressing functions. For example, the positional relationship between the white line and the own vehicle is used as determination data in the lane deviation preventing function, and the advancing direction and the moving direction are used as determination data in the reverse travel preventing function. On a road having no travel experience where reverse travel occurs, there is no empirical knowledge, and control data (determination data) is generated only by collective knowledge. Then, it is possible to compare the determination data with the advancing direction of the own vehicle, and issue a warning for reverse travel.

Although the activation threshold value of the erroneous operation suppressing function of the driving assistance device 100 has been described above, the activation threshold value can also be applied to the control value output by the driving assistance function. That is, the control target value of the deceleration at the time of activation of the driving assistance function, the control target value of the inter-vehicle distance, and the like may be determined by combining the collective knowledge information and the empirical knowledge information using the combination ratio of the present example.

In the above-described example, one driver is assumed for one vehicle, but actually, there are a plurality of drivers for one vehicle in a vehicle shared by family or a rental car. Since the empirical knowledge information is information associated with the driver instead of the vehicle, it is preferable to provide the driver discrimination device in the information acquisition device 10 and collect and use the empirical knowledge information for each driver.

As described above, the electronic control device (driving assistance device 100) according to the present invention includes a travel experience determination unit 53 that determines travel experience at a travel position of an own vehicle; a collective knowledge storage unit 21 that stores collective knowledge information generated from data related to operations of a plurality of vehicles; an empirical knowledge storage unit 22 that stores empirical knowledge information generated from data related to operations of the own vehicle; a combination ratio determination unit 54 that determines a combination ratio pattern of the collective knowledge information and the empirical knowledge information; a data generation unit (determination data generation unit 23) that combines the collective knowledge information and the empirical knowledge information based on the travel experience the combination ratio pattern to generate control data of the own vehicle, a position information acquisition unit 13 that acquires position information of the own vehicle; a travel environment acquisition unit 11 that acquires a travel environment around the own vehicle, a collective knowledge storage unit 21 that stores collective knowledge information generated from data obtained by collecting operations of a plurality of vehicles including another vehicle, an empirical knowledge storage unit 22 that stores empirical knowledge information generated from data obtained by collecting operations of the own vehicle; and a data generation unit (determination data generation unit 23) that combines the collective knowledge information and the empirical knowledge information at a predetermined combination ratio to generate control data at the own vehicle position, where the determination data generation unit 23 includes a travel experience determination unit 53 that determines travel experience at the own vehicle position; and a combination ratio determination unit 54 that determines the combination ratio based on a travel environment and the travel experience, so that the collective knowledge information can be emphasized to improve safety or the empirical knowledge information can be emphasized to improve convenience according to the travel experience of the own vehicle. As a result, unlike the conventional system, the control data can be appropriately set according to the situation.

Note that the present invention is not limited to the above-described examples, and includes various modified examples and equivalent configurations within the spirit of the appended claims. For example, the above-described examples have been described in detail for easy understanding of the present invention, and the present invention is not necessarily limited to those having all the described configurations. Furthermore, a part of the configuration of one example may be replaced with the configuration of another example. In addition, the configuration of another example may be added to the configuration of one example. In addition, a part of the configuration of each example may be added, deleted, or replaced with respect to another configuration.

In addition, a part of or all of the above-described configurations, functions, processing units, processing means, and the like may be realized by hardware by, for example, designing with an integrated circuit, or may be realized by software by a processor interpreting and executing a program for realizing each function.

Information such as a program, a table, and a file for realizing each function can be stored in a storage device such as a memory, a hard disk, and a solid state drive (SSD), or a recording medium such as an IC card, an SD card, and a DVD.

In addition, the control lines and the information lines indicate what is considered to be necessary for the description, and do not necessarily indicate all the control lines and the information lines necessary for the implementation. In practice, it may be considered that almost all the configurations are connected to each other.

1. An electronic control device comprising:
a travel experience determination unit that determines travel experience at a travel position of an own vehicle;
a collective knowledge storage unit that stores collective knowledge information generated from data related to operations of a plurality of vehicles;
an empirical knowledge storage unit that stores empirical knowledge information generated from data related to operation of the own vehicle;
a combination ratio determination unit that determines a combination ratio pattern of the collective knowledge information and the empirical knowledge information; and
a data generation unit that generates control data for the own vehicle by combining the collective knowledge information and the empirical knowledge information based on the travel experience and the combination ratio pattern.

2. The electronic control device according to claim 1,
further comprising a travel environment acquisition unit that acquires a travel environment around the own vehicle, wherein
the combination ratio determination unit changes the combination ratio pattern depending on the acquired travel environment.

3. The electronic control device according to claim 2, wherein the combination ratio determination unit selects a function representing a relationship between the travel experience and the combination ratio according to the travel environment, and determines the combination ratio pattern depending on the selected function.

4. The electronic control device according to claim 2, wherein the travel environment acquisition unit acquires a degree of congestion around the own vehicle as the travel environment.

5. The electronic control device according to claim 2, wherein when the travel experience is smaller than a predetermined value, the combination ratio determination unit determines a combination ratio to generate control data only with the collective knowledge information without using the empirical knowledge information.

6. The electronic control device according to claim 4, wherein the combination ratio determination unit determines a combination ratio so that the empirical knowledge information increases when a congestion degree is high, and determines the combination ratio so that the collective knowledge information increases when the congestion degree is low.

7. The electronic control device according to claim 1, further comprising a determination processing unit that determines occurrence of an erroneous operation of the own vehicle based on the control data and operation information of the own vehicle.

8. A vehicle control method executed by an electronic control device,
the electronic control device including a processor that executes a program, a storage device accessible by the processor, and a travel experience acquisition unit that determines travel experience at a travel position of an own vehicle, and
the storage device storing collective knowledge information generated from data obtained by collecting operations of a plurality of vehicles including other vehicles, and empirical knowledge information generated from data obtained by collecting operations of an own vehicle,
the vehicle control method comprising:
determining, by the processor, a combination ratio pattern of the collective knowledge information and the empirical knowledge information, and
generating, by the processor, control data for the own vehicle by combining the collective knowledge information and the empirical knowledge information based on the travel experience and the combination ratio pattern.
